(19) United States
(12) Patent Application Publication
(10) Pub. No.: US 2021/0103733 A1
(43) Pub. Date: Apr. 8, 2021

(54) VIDEO PROCESSING METHOD, APPARATUS, AND NON-TRANSITORY COMPUTER-READABLE STORAGE MEDIUM

(71) Applicant: ZHEJIANG SENSETIME TECHNOLOGY DEVELOPMENT CO.,LTD., Hangzhou (CN)

(72) Inventors: Boyuan JIANG, Hangzhou (CN); Mengmeng WANG, Hangzhou (CN); Weihao GAN, Hangzhou (CN)

(21) Appl. No.: 17/126,633

(22) Filed: Dec. 18, 2020

Related U.S. Application Data
(63) Continuation of application No. PCT/CN2019/121975, filed on Nov. 29, 2019.

(30) Foreign Application Priority Data
Jul. 19, 2019 (CN) 201910656059.9

(51) Int. Cl. G06K 9/00; G06K 9/62; G06T 7/246; G06N 3/04; G06N 3/08

(52) U.S. Cl. CPC G06K 9/00718; G06K 9/00744; G06K 9/6232; G06T 7/246; G06K 9/6256; G06T 2207/20081; G06N 3/04; G06N 3/08; G06T 2207/10016; G06T 2207/20084; G06K 9/00765

(57) ABSTRACT

The present disclosure relates to a video processing method and an apparatus, an electronic device, and a storage medium. The method includes: performing a feature extraction on a plurality of target video frames of a video to be processed through a feature extraction network, to obtain feature maps of the plurality of target video frames; performing an action recognition process on the feature maps of the plurality of target video frames through an M-level action recognition network, to obtain action recognition features of the plurality of target video frames; and determining a classification result of the video to be processed according to the action recognition features of the plurality of target video frames. According to the video processing method of the embodiments of the present disclosure, the action recognition features of the target video frames may be obtained through a multi-level action recognition network, and the classification result of the video to be processed may be further obtained, without action recognition by a process such as optical flow or 3D convolution, reducing the amount of computation, improving the processing efficiency, allowing for online real-time classification on the video to be processed, and enhancing practicability of the video processing method.

The present application is a continuation of and claims priority under 35 U.S.C. 120 to PCT Application No. PCT/CN2019/121975, filed on Nov. 29, 2019, which claims priority to Chinese Patent Application No. 201910656059.9, filed with the Chinese National Intellectual Property Administration (CNIPA) on Jul. 19, 2019 and entitled “Video Processing Method, Apparatus, Electronic Device and Storage Medium”. All the above-referenced priority documents are incorporated herein by reference.

### TECHNICAL FIELD

The present disclosure relates to the field of computer vision technology, and more particularly, to a video processing method, an apparatus, and a non-transitory computer-readable storage medium.

### BACKGROUND

A video is composed of a plurality of video frames, can record information such as an action and a behavior, and has diversified application scenarios. However, a video not only has a large number of frames and causes a large amount of processing computations, but also has an association relationship with time. For example, information such as an action or a behavior is expressed through contents in the plurality of video frames and the time corresponding to each video frame. In the related art, spatiotemporal features, motion features and the like can be obtained through a processing such as optical flow or 3D convolution.

### SUMMARY

The present disclosure provides a video processing method, an apparatus, an electronic device, and a storage medium.

According to one aspect of the present disclosure, there is provided a video processing method, comprising: performing a feature extraction on a plurality of target video frames of a video to be processed through a feature extraction network, to obtain feature maps of the plurality of target video frames; performing an action recognition process on the feature maps of the plurality of target video frames through an M-level action recognition network, to obtain action recognition features of the plurality of target video frames; wherein M is an integer greater than or equal to 1, the action recognition process comprises a spatiotemporal feature extraction process based on the feature maps of the plurality of target video frames, and a motion feature extraction process based on motion difference information between the feature maps of the plurality of target video frames, the action recognition feature comprises spatiotemporal feature information and motion feature information; and determining a classification result of the video to be processed according to the action recognition features of the plurality of target video frames.

According to another aspect of the present disclosure, there is provided a video processing apparatus, comprising: a feature extraction module configured to perform a feature extraction on a plurality of target video frames of a video to be processed through a feature extraction network, to obtain feature maps of the plurality of target video frames; an action recognition module configured to perform an action recognition process on the feature maps of the plurality of target video frames through an M-level action recognition network, to obtain action recognition features of the plurality of target video frames; wherein M is an integer greater than or equal to 1, the action recognition process comprises a spatiotemporal feature extraction process based on the feature maps of the plurality of target video frames, and a motion feature extraction process based on motion difference information between the feature maps of the plurality of target video frames, the action recognition feature comprises spatiotemporal feature information and motion feature information; and a classification module configured to determine a classification result of the video to be processed according to the action recognition features of the plurality of target video frames.

According to one aspect of the present disclosure, there is provided an electronic apparatus, comprising:

a processor; and a memory for storing processor executable instructions; wherein a processor is configured to execute the video processing method as described above.

According to one aspect of the present disclosure, there is provided a computer-readable storage medium having computer program instructions stored thereon, wherein the computer program instructions, when executed by a processor, implement the video processing method as described above.

According to one aspect of the present disclosure, there is provided a computer program comprising computer-readable codes, wherein a processor in an electronic apparatus is configured to execute the video processing method as described above when the computer-readable codes is running on the electronic apparatus.

It should be appreciated that the above general description and the following detailed descriptions are only exemplary and explanatory, rather than limiting the present disclosure.

Other features and aspects of the present disclosure will become apparent with the following detailed descriptions of exemplary embodiments with reference to the accompanying drawings.

### BRIEF DESCRIPTION OF THE DRAWINGS

The drawings herein are incorporated into the specification and constitute a part of the specification. The drawings illustrate embodiments according to the present disclosure and are used together with the specification to explain the technical solutions of the present disclosure.

FIG. 1 shows a flow chart of a video processing method according to an embodiment of the present disclosure;

FIG. 2 shows a flow chart of a video processing method according to an embodiment of the present disclosure;

FIG. 3 shows a schematic diagram of an action recognition network according to an embodiment of the present disclosure;

FIG. 4 shows a schematic diagram of a spatiotemporal feature extraction process according to an embodiment of the present disclosure;

FIG. 5 shows a schematic diagram of a motion feature extraction process according to an embodiment of the present disclosure;

FIG. 6 shows a flow chart of a video processing method according to an embodiment of the present disclosure;

FIG. 7 shows a schematic diagram of the application of a video processing method according to an embodiment of the present disclosure;

FIG. 8 shows a block diagram of a video processing apparatus according to an embodiment of the present disclosure;

FIG. 9 shows a block diagram of a video processing apparatus according to an embodiment of the present disclosure;

FIG. 10 shows a block diagram of an electronic device according to an embodiment of the present disclosure; and

FIG. 11 shows a block diagram of an electronic device according to an embodiment of the present disclosure.

### DETAILED DESCRIPTION

Various exemplary embodiments, features, and aspects of the present disclosure are described in detail as below with reference to the drawings. In the drawings, same numerical references indicate elements with same or similar functions. Although the drawings show various aspects of the embodiments, they are not necessarily drawn to scale, unless otherwise specified.

The word “exemplary” specifically used herein means “serving as an example, embodiment, or illustration”. Any embodiment described herein as “exemplary” is not necessarily construed as preferred to or better than other embodiments.

The term “and/or” used herein is only a relationship describing associated objects, which means that there can be three relationships. For example, A and/or B can be: only A exists, both A and B exist, and only B exists. In addition, the term “at least one of” used herein means any one of or a combination of at least two of multiple objects, for example, “including at least one of A, B, and C” may mean including any one or more elements selected from the collection formed by A, B and C.

In addition, in order to better illustrate the present disclosure, numerous specific details are given in the detailed descriptions as below. Those skilled in the art should understand that the present disclosure can also be implemented without certain specific details. In some examples, methods, means, elements, and circuits well known to those skilled in the art are not described in detail, so as to highlight the essence of the present disclosure.

FIG. 1 shows a flow chart of a video processing method according to an embodiment of the present disclosure. As shown in FIG. 1, the method includes:

In step S11, performing a feature extraction on a plurality of target video frames of a video to be processed through a feature extraction network, to obtain feature maps of the plurality of target video frames;

In step S12, performing an action recognition process on the feature maps of the plurality of target video frames through an M-level action recognition network, to obtain action recognition features of the plurality of target video frames; where, M is an integer greater than or equal to 1; the action recognition process includes a spatiotemporal feature extraction process based on the feature maps of the plurality of target video frames, and a motion feature extraction process based on motion difference information between the feature maps of the plurality of target video frames, wherein the action recognition features include spatiotemporal feature information and motion feature information;

In step S13, determining a classification result of the video to be processed according to the action recognition features of the plurality of target video frames.

According to the video processing method of the embodiment of the present disclosure, the action recognition features of the target video frames can be obtained through a multi-level action recognition network, to further obtain the classification result of the video to be processed, without action recognition by a process such as optical flow or 3D convolution, reducing the amount of computation, improving the processing efficiency, allowing for online real-time classification on the video to be processed, and enhancing practicability of the video processing method.

In a possible implementation, the method may be executed by a terminal device, which may be a user equipment (UE), a mobile device, a user terminal, a terminal, a cell phone, a cordless phone, a personal digital assistant (PDA), a handheld device, a computing device, a vehicle-mounted device, or a wearable device, etc. The method can be implemented by a processor invoking computer-readable instructions stored in a memory. Alternatively, the method is executed by a server.

In a possible implementation, the video to be processed may be a video captured by any video acquisition device. A video frame to be processed may include one or more target objects (for example, a person, a vehicle, and/or an item like a teacup). The target object may be performing a certain action (for example, picking up a cup, walking, etc.). The present disclosure does not limit the content of the video to be processed.

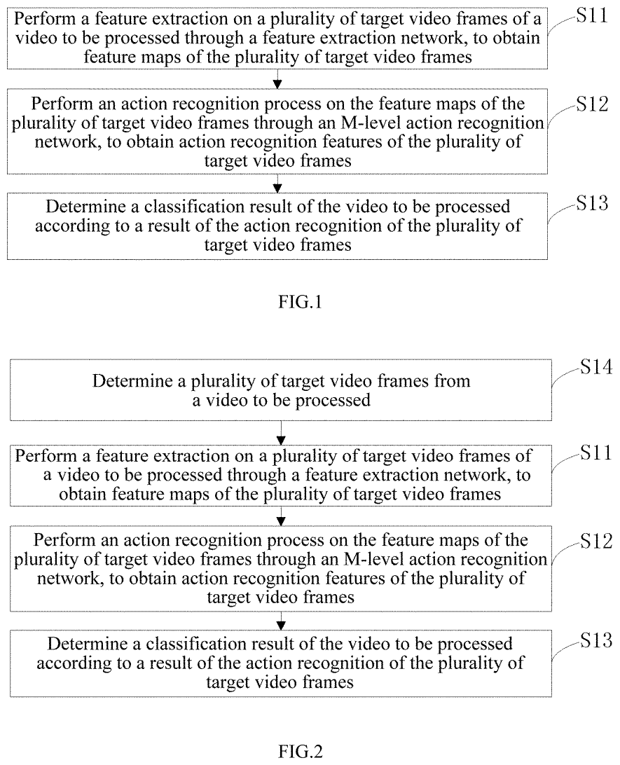

FIG. 2 shows a flow chart of a video processing method according to an embodiment of the present disclosure. As shown in FIG. 2, the method includes:

In step S14, determining a plurality of target video frames from the video to be processed.

In a possible implementation, the step S14 may include: dividing the video to be processed into a plurality of video clips; and determining randomly at least one target video frame from each video clip, to obtain the plurality of target video frames.

In an example, the video to be processed may include a plurality of video frames, and the video to be processed may be divided, for example, into T video clips (where T is an integer greater than 1). Sampling can be performed on the plurality of video frames of each video clip. For example, at least one target video frame is sampled from each video clip. For example, the video to be processed can be divided at equal intervals into, e.g., 8 or 16 clips. Random sampling is performed on each video clip. For example, one video frame can be randomly selected from each video clip as a target video frame, and then the plurality of target video frames can be obtained.

In an example, random sampling can be performed on all video frames of the video to be processed, to obtain a plurality of target video frames. Alternatively, a plurality of video frames can be selected as target video frames at equal intervals. For example, the 1st video frame, the 11th video frame, the 21st video frame and the likes may be selected. Alternatively, all the video frames of the video to be processed can be determined as the target video frames. The present disclosure does not limit the method of selecting the target video frames.

In this way, the target video frames can be determined from the plurality of video frames of the video to be processed, and then the target video frames can be processed, which can save the computing resources and improve the processing efficiency.

In a possible implementation, in the step S11, feature extraction can be performed on the plurality of target video frames of the video to be processed, to obtain feature maps of the plurality of target video frames. The feature extraction process may be performed through a feature extraction network of neural network, and the feature extraction network may be a part of a neural network (for example, a sub-network or a neural network of a certain level). In an example, the feature extraction network may include one or more convolution layers, and may perform feature extraction on the plurality of target video frames to obtain the feature maps of the plurality of target video frames.

In the example, the feature extraction process can be performed on T target video frames (where T is an integer greater than 1) through the feature extraction network, and each target video frame can be divided into C channels (where C is a positive integer) and input into the feature extraction network. For example, the target video frame is an RGB image which can be input to the feature extraction network through three channels of R, G, and B. Each target video frame has a size of H×W (where H is a height of an image, which can be represented as the number of pixels in a height direction of the image, and W is a width of the image, which can be represented as the number of pixels in a width direction of the image). Therefore, a dimension of the target video frames input into the feature extraction network is T×C×H×W. For example, T can be 16, C can be 3, and H and W can both be 224; then the dimension of the target video frames input into the feature extraction network is 16×3×224×224.

In an example, the neural network can perform batch processing on a plurality of videos to be processed. For example, the feature extraction network can perform the feature extraction process on the target video frames of N videos to be processed; then the dimension of the target video frames input into the feature extraction network is N×T×C×H×W.

In an example, the feature extraction network may perform the feature extraction process on target video frames with a dimension of T×C×H×W, to obtain T groups of feature maps corresponding to the T target video frames respectively. For example, in the feature extraction process, the feature map of the target video frame may have a size smaller than that of the target video frame, but with a greater number of channels than the target video frame, so that the receptive field of the target video frame can be increased, that is, the value of C can be increased, while the values of H and W can be reduced. For example, the dimension of the target video frames input into the feature extraction network is 16×3×224×224; then the number of channels of the target video frames can be increased by a factor of 16, which means that the value of C can be increased to 48; and the size of the feature maps of the target video frames can be reduced by a factor of 4, that is, the values of H and W can be both reduced to 56. The number of channels of the feature map corresponding to each target video frame is 48, the size of each feature map is 56×56, and the dimension of the feature map can be 16×48×56×56. The above data is only an example, and the present disclosure does not limit the dimensions of the target video frame and the feature map.

In a possible implementation, in the step S12, action recognition can be performed on the feature maps of the T target video frames, to respectively obtain the action recognition features of the target video frames. The action recognition process can be performed on the feature maps of the plurality of target video frames through an M-level action recognition network of the neural network. The M-level action recognition network can be M action recognition networks that are cascaded, wherein each action recognition network can be a part of the neural network.

In a possible implementation, the step S12 may include: processing the feature maps of the plurality of target video frames through a first level action recognition network, to obtain first level action recognition features; processing (i−1)^{th} level action recognition features through an i^{th} level action recognition network to obtain i^{th} level action recognition features, where i is an integer and 1<i<M, action recognition features of respective levels correspond to the feature maps of the plurality of target video frames; and processing (M−1)^{th} level action recognition features through an M^{th} level action recognition network to obtain action recognition features of the plurality of target video frames.

In a possible implementation, the M-level action recognition network is cascaded, and output information of the action recognition network of each level (that is, the action recognition features by the action recognition network of this level) can be used as input information for the action recognition network of the next level. The first level action recognition network may process the feature maps of the target video frames, and output the first level action recognition features. The first level action recognition features can be used as input information for the second level action recognition network, that is, the second level action recognition network may process the first level action recognition features to obtain the second level action recognition features, and the second level action recognition features can be used as input information for the third level action recognition network, and so on.

In a possible implementation, taking the i^{th} level action recognition network as an example, the i^{th} level action recognition network can take the (i−1)^{th} level action recognition features as input information for process. Processing the (i−1)^{th} level action recognition features through the i^{th} level action recognition network to obtain the i^{th} action recognition features includes: performing a first convolution process on the (i−1)^{th} level action recognition features to obtain first feature information; performing a spatiotemporal feature extraction process on the first feature information to obtain spatiotemporal feature information; performing a motion feature extraction process on the first feature information to obtain motion feature information; and obtaining the i^{th} level action recognition features based on the spatiotemporal feature information and the motion feature information.

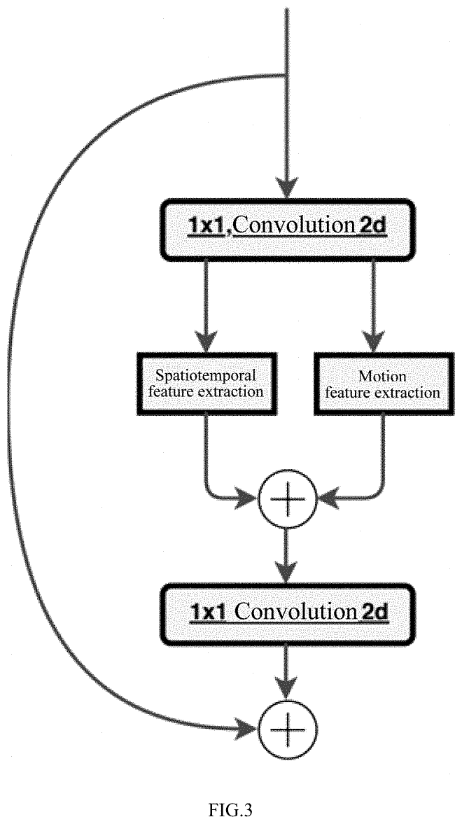

FIG. 3 shows a schematic diagram of an action recognition network according to an embodiment of the present disclosure. Structures of the first level action recognition network up to the M^{th} level action recognition network are all of the structure shown in FIG. 3. Taking the i^{th} level action recognition network as an example, the i^{th} level action recognition network may take the (i−1)^{th} level action recognition features as input information for process. In an example, the i^{th} level action recognition network can perform the first convolution process on the (i−1)^{th} level action recognition features through a 2D convolution layer with a convolution kernel of 1×1, and can reduce the dimension of the (i−1)^{th} level action recognition features. In an example, the 2D convolution layer with a convolution kernel of 1×1 can reduce the number of channels of the (i−1)^{th} level action recognition features, for example, can reduce the number of channels C by a factor of 16, to obtain the first feature information. The present disclosure does not limit the factor of reduction.

In an example, in the first level action recognition network, the first level action recognition network may take the feature maps of the target video frames as input information for process. The first level action recognition network may perform the first convolution process on the feature maps of the target video frames through the 2D convolution layer with a convolution kernel of 1×1, and may reduce the dimension of the feature maps, to obtain the first feature information.

In a possible implementation, the i^{th} level action recognition network can perform a spatiotemporal feature extraction process and a motion feature extraction process on the first feature information separately, and can process the first feature information through two branches (a spatiotemporal feature extraction branch and a motion feature extraction branch) respectively, to obtain the respective spatiotemporal feature information and motion feature information.

In a possible implementation, obtaining the i^{th} level action recognition features based on the spatiotemporal feature information and the motion feature information may include: obtaining the i^{th} level action recognition features based on the spatiotemporal feature information, the motion feature information, and the (i−1)^{th} level action recognition features. For example, the spatiotemporal feature information and the motion feature information can be summed, and the summation result can be subjected to a convolution process. Further, the result of the convolution process can be summed with the (i−1)^{th} level action recognition features to obtain the i^{th} level action recognition features.

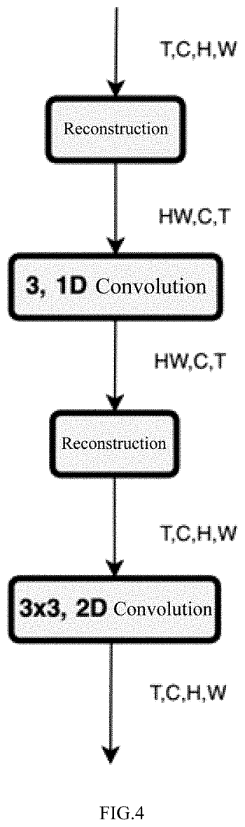

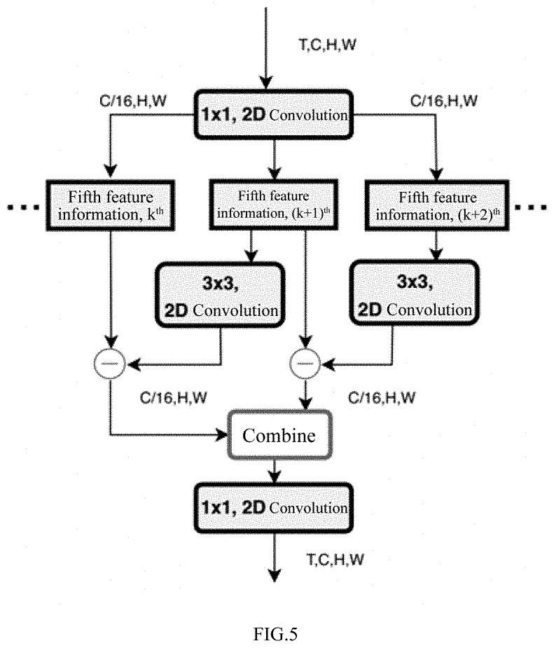

FIG. 4 shows a schematic diagram of a spatiotemporal feature extraction process according to an embodiment of the present disclosure. Performing a spatiotemporal feature extraction process on the first feature information to obtain the spatiotemporal feature information includes: performing dimensional reconstruction processes respectively on the first feature information corresponding to the feature maps of the plurality of target video frames, to obtain second feature information, wherein the second feature information has a different dimension from the first feature information; performing second convolution processes respectively on the channels of the second feature information, to obtain third feature information, wherein the third feature information represents time features of the feature maps of the plurality of target video frames; performing the dimensional reconstruction process on the third feature information to obtain fourth feature information, wherein the fourth feature information has a same dimension as the first feature information; and performing a spatial feature extraction process on the fourth feature information, to obtain the spatiotemporal feature information.

In a possible implementation, the dimension of the first feature information is T×C×H×W, wherein the values of the parameters C, H, and W are different from those of the feature maps of the target video frames. The first feature information can be represented by a feature matrix, which can be represented as multiple row vectors or column vectors. The first feature information includes multiple row vectors or column vectors, and performing dimensional reconstruction processes respectively on the first feature information corresponding to the feature maps of the plurality of target video frames includes: performing splicing processes on the multiple row vectors or column vectors of the first feature information to obtain the second feature information, wherein the second feature information includes one row vector or column vector. The first feature information (feature matrix) can be reconstructed, and the dimension of the feature matrix can be changed into HW×C×T to obtain the second feature information that has a dimension different from the first feature information. For example, the first feature information includes T groups of feature matrices, and the number of channels in each group of feature matrices is C (for example, the number of feature matrices in each group is C), and the size of each feature matrix is H×W. Each feature matrix can be spliced separately. For example, the feature matrix can be regarded as H row vectors or W column vectors, and the H row vectors or the W column vectors can be spliced to form a row vector or a column vector. That row vector or column vector is then the second feature information. The value of HW may be equal to the product of H and W. The present disclosure does not limit the method of reconstruction process.

In a possible implementation, the second convolution process may be performed on each channel of the second feature information to obtain the third feature information. In an example, the second convolution process can be performed on each channel of the second feature information through a 1D depth separation convolution layer with a convolution kernel of 3×1. For example, T groups of second feature information each includes C channels. For example, the number of second feature information in each group is C, and the second convolution process can be performed respectively on the C second feature information of each group to obtain the T groups of third feature information. The T groups of third feature information may indicate the time features of feature maps of the plurality of target video frames; that is, the third feature information has temporal information of each target video frame. In an example, the spatiotemporal information contained in the second feature information of each channel may be different from each other. The second convolution process is performed respectively on the second feature information of each channel, to obtain the third feature information of each channel. Moreover, performing the second convolution process on the reconstructed second feature information for each channel through the 1D convolution layer with the convolution kernel of 3×1 requires a relatively small amount of computation. That is, compared with performing 2D convolution or 3D convolution on the feature maps, performing 1D convolution process on a row vector or a column vector has a smaller amount of computation, improving the processing efficiency. In an example, the dimension of the third feature information is HW×C×T; that is, each third feature information may be a row vector or a column vector.

In a possible implementation, the third feature information can be reconstructed. For example, each third feature information (in the form of a row vector or a column vector) can be reconstructed into a matrix, to obtain the fourth feature information, wherein the fourth feature information has a same dimension as the first feature information. For example, each third feature information is a row vector or column vector with a length of HW. The third feature information can be divided into W column vectors with a length of H or H row vectors with a length of W, and the row vectors or column vectors are combined into a feature matrix (i.e., the fourth feature information), wherein the dimension of the fourth feature information is T×C×H×W. The present disclosure does not limit the parameters of the fourth feature information.

In a possible implementation, the convolution process can be performed on the fourth feature information through a 2D convolution layer with a convolution kernel of 3×3, and spatial features of the fourth feature information can be extracted to obtain the spatiotemporal feature information; that is, the feature information representing the position of the target object in the fourth feature information is extracted and combined with the temporal information to represent the spatiotemporal feature information. The spatiotemporal feature information may be a feature matrix with a dimension of T×C×H×W, and H and W of the spatiotemporal feature information may be different from the fourth feature information.

In this way, the spatiotemporal information of each channel can be obtained to make the spatiotemporal information complete; and the dimension of the first feature information can be changed through a reconstruction process, such that the convolution process can be performed in a less computationally expensive manner. For example, the second convolution process can be performed by means of a 1D convolution process, which can simplify the computation and improve the processing efficiency.

FIG. 5 shows a schematic diagram of a motion feature extraction process according to an embodiment of the present disclosure. Performing a motion feature extraction process on the first feature information to obtain the motion feature information may include: performing a dimensional reduction process on the channels of the first feature information to obtain fifth feature information, wherein the fifth feature information corresponds to the target video frames of the video to be processed respectively; performing a third convolution process on the fifth feature information that corresponds to a (k+1)^{th} target video frame, which then is subtracted by the fifth feature information that corresponds to a k^{th} target video frame to obtain sixth feature information corresponding to the k^{th} target video frame, wherein k is an integer and 1≤k<T, T is the number of target video frames, and T is an integer greater than 1, the sixth feature information represents motion difference information between the fifth feature information corresponding to the (k+1)^{th} target video frame and the fifth feature information corresponding to the k^{th} target video frame; and performing a feature extraction process on the sixth feature information corresponding to the respective target video frames to obtain the motion feature information.

In a possible implementation, a dimensional reduction process can be performed on the channels of the first feature information to obtain the fifth feature information. For example, the dimensional reduction process can be performed on the channels of the first feature information through a 2D convolution layer with a convolution kernel of 1×1, that is, the number of channels can be reduced. In an example, the number of channels C for the first feature information with a dimension of T×C×H×W can be reduced to C/16. The fifth feature information corresponding to the respective target video frames is obtained, with the dimension of the fifth feature information being T×C/16×H×W, which means that it includes T groups of fifth feature information corresponding to T target video frames respectively, and the dimension of each group of fifth feature information is C/16×H×W.

In a possible implementation, taking the fifth feature information corresponding to the k^{th} target video frame (referred to as fifth feature information k for short) as an example, a third convolution process may be performed on each channel of the fifth feature information corresponding to the (k+1)^{th} target video frame (referred to as fifth feature information k+1 for short). For example, the third convolution process can be performed on the fifth feature information k+1 through a 2D depth separation convolution layer with a convolution kernel of 3×3, and the fifth feature information k is subtracted from the result of the third convolution process to obtain the sixth feature information corresponding to the k^{th} target video frame, wherein the sixth feature information has a same dimension as the fifth feature information, which is C/16×H×W. The third convolution process can be performed on each fifth feature information separately, which can then be subtracted by the previous fifth feature information to obtain the sixth feature information. The sixth feature information can represent the motion difference information between the fifth feature information corresponding to two adjacent target video frames; that is, it can be used to represent the difference in action of the target object in the two target video frames so as to determine the action of the target object. In an example, T−1 pieces of sixth feature information can be obtained from the process of subtraction, the fifth feature information corresponding to the T^{th} target video frame minus the result of the third convolution process on a matrix with all parameters being 0 or directly minus the matrix with all parameters being 0 obtains the sixth feature information corresponding to the T^{th} target video frame. Alternatively, the matrix with all parameters being 0 can be used as the sixth feature information to obtain the sixth feature information corresponding to the T^{th} target video frame. That is, a total of T pieces of sixth feature information corresponding to T target video frames can be obtained. Further, the T pieces of sixth feature information can be combined to obtain the sixth feature information with a dimension of T×C/16×H×W.

In a possible implementation, the feature extraction process can be performed on the sixth feature information with a dimension of T×C/16×H×W. For example, the dimension of the sixth feature information can be increased through a 2D convolution layer with a convolution kernel of 1×1. For example, a dimensional increase can be applied with regard to the number of channels, i.e., the number of channels C/16 can be increased to C, to obtain the motion feature information. The dimension of the motion feature information is consistent to the dimension of the spatiotemporal feature information, which are both T×C×H×W.

In a possible implementation, as shown in FIG. 3, the i^{th} level action recognition features can be obtained based on the spatiotemporal feature information, the motion feature information, and the (i−1)^{th} level action recognition features. In an example, this step may include: performing a summation process on the spatiotemporal feature information and the motion feature information to obtain seventh feature information; performing a fourth convolution process on the seventh feature information, and summing it with the (i−1)^{th} level action recognition features to obtain the i^{th} level action recognition features.

In a possible implementation, the dimensions of the spatiotemporal feature information and the motion feature information are the same, which are both T×C×H×W. Multiple pieces of feature information of the spatiotemporal feature information and the motion feature information (for example, respective feature maps or feature matrices) can be separately summed to obtain the seventh feature information, and the dimension of the seventh feature information is T×C×H×W.

In a possible implementation, the fourth convolution process may be performed on the seventh feature information. For example, the fourth convolution process may be performed on the seventh feature information through a 2D convolution layer with a convolution kernel of 1×1. The dimension of the seventh feature information can be increased, and the dimension of the seventh feature information can be changed into the same dimension as the (i−1)^{th} level action recognition features, for example, the number of channels can be increased by a factor of 16. Further, the result of the fourth convolution process can be summed with the (i−1)^{th} level action recognition features, to obtain the i^{th} level action recognition features.

In a possible implementation, the feature maps of the target video frames and the result of the fourth convolution process can be summed through the first level action recognition network, to obtain the first level action recognition features; and the first level action recognition features can be used as input information of the second level action recognition network.

In this way, the motion feature information can be obtained by subtracting the previous fifth feature information from the fifth feature information which has been subjected to the third convolution process, so as to simplify the computation and improve the processing efficiency.

In a possible implementation, the action recognition features can be obtained in a level-wise manner according to the above approach, and the (M−1)^{th} level action recognition features can be processed through the M^{th} level action recognition network according to the above approach, to obtain the action recognition features of the plurality of target video frames, which means that the M^{th} level action recognition features are taken as the action recognition features of the target video frames.

In a possible implementation, in the step S13, a classification result of the video to be processed can be obtained according to the action recognition features of the plurality of target video frames. The step S13 may include: performing a full connection process on the action recognition features of the target video frames respectively, to obtain the classification information of the respective target video frame; and performing an averaging process on the classification information of the respective target video frames, to obtain a classification result of the video to be processed.

In a possible implementation, the full connection process can be performed on the action recognition features of respective target video frames through a full connection layer of the neutral network, to obtain the classification information of the respective target video frames. In an example, the classification information of each target video frame may be a feature vector, that is, the full connection layer may output T feature vectors. Further, the T feature vectors may be averaged to obtain the classification result of the video to be processed. The classification result may also be a feature vector, which may represent probabilities of the video to be processed belonging to categories.

In an example, the classification result may be a 400-dimension vector, which includes 400 parameters respectively representing the probabilities of the video to be processed belonging to 400 categories. The categories may be categories of the actions of the target object in the video to be processed, for example, actions such as walking, raising a cup and eating. For example, in this vector, the second parameter has the largest value, that is, the probability that the video to be processed belongs to the second category is the highest. It can be determined that the video to be processed belongs to the second category; for example, it can be determined that the target object in the video to be processed is walking. The present disclosure does not limit the type and dimension of classification result.

According to the video processing method of the embodiment of the present disclosure, the target video frames can be determined from a plurality of video frames of the video to be processed, and then the target video frames can be processed, so as to save the computing resources and improve the processing efficiency. The action recognition network of each level can obtain the spatiotemporal information of each channel to make the spatiotemporal information complete, and the dimension of the first feature information can be changed through a reconstruction process, such that the convolution process can be performed in a less computationally expensive manner. The fifth feature information can be subjected to the third convolution process, and then may be subtracted by the previous fifth feature information, which can simplify the computation. Further, the action recognition result of the action recognition network of each level can be obtained, and then the classification result of the video to be processed can be obtained. The spatiotemporal feature information and the motion feature information can be obtained through the input target video frame (RGB image) without performing action recognition by a process such as optical flow or 3D convolution, reducing the number of parameters of input, reducing the amount of computation, improving the processing efficiency, allowing for the online real-time classification of the video to be processed, and enhancing the practicability of the video processing method.

In a possible implementation, the video processing method may be implemented through a neural network, and the neural network at least includes the feature extraction network and the M-level action recognition network. The neural network may further include a full connection layer to perform a full connection process on the action recognition features.

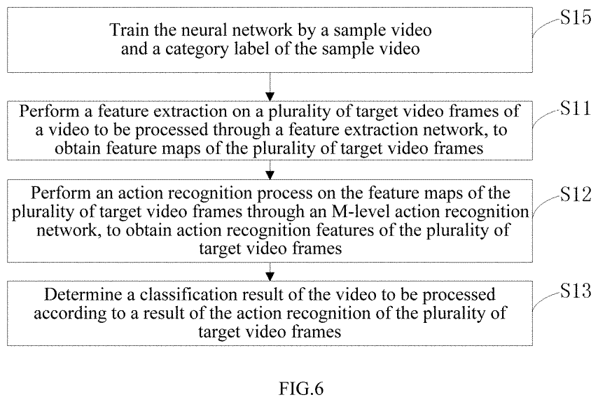

FIG. 6 shows a flow chart of a video processing method according to an embodiment of the present disclosure. As shown in FIG. 6, the method further includes:

In step S15, training the neural network by a sample video and a category label of the sample video.

In a possible implementation, the step S15 may include: determining a plurality of sample video frames from a sample video; processing the sample video frames through the neural network, to determine a classification result of the sample video; determining a network loss of the neural network according to the classification result and category label of the sample video; and adjusting network parameters of the neural network according to the network loss.

In a possible implementation, the sample video may include a plurality of video frames, and the sample video frames may be determined from the plurality of video frames of the sample video. For example, random sampling may be performed, or the sample video may be divided into a plurality of video clips where sampling is performed on each video clip to obtain the sample video frames.

In a possible implementation, the sample video frames can be input to the neural network and subjected to the feature extraction process through the feature extraction network and the action recognition process through the M-level action recognition network. Further, after the full connection process by the full connection layer, the classification information of respective sample video frames can be obtained; and the classification information of the respective sample video frames is averaged to obtain the classification result of the sample video.

In a possible implementation, the classification result may be a multidimensional vector (possibly with error) representing the classification of the sample video. The sample video may have a category label, which may represent the actual category of the sample video (without error). The network loss of the neural network may be determined according to the classification result and the category label. For example, a cosine distance or an Euclidean distance between the classification result and the category label can be determined, and the network loss can be determined from the difference between the cosine distance or the Euclidean distance and 0. The present disclosure does not limit the method of determining the network loss.

In a possible implementation, the network parameters of the neural network can be adjusted according to the network loss. For example, gradients of the network loss with regard to respective parameters of the neural network can be determined, and the respective network parameters are adjusted with a gradient descent method in the direction minimizing the network loss. The network parameters can be adjusted multiple times in the above manner (that is, multiple cycles of training are carried out with a plurality of sample videos), and a trained neutral network is obtained upon the meeting of a training condition. The training condition may include a number of trainings (i.e., a number of training cycles). For example, when the number of trainings reaches a preset number, the training condition is met. Alternatively, the training condition may include a magnitude or convergence/divergence of the network loss. For example, when the network loss is less than or equal to a loss threshold or converges within a preset interval, the training condition is met. The present disclosure does not limit the training condition.

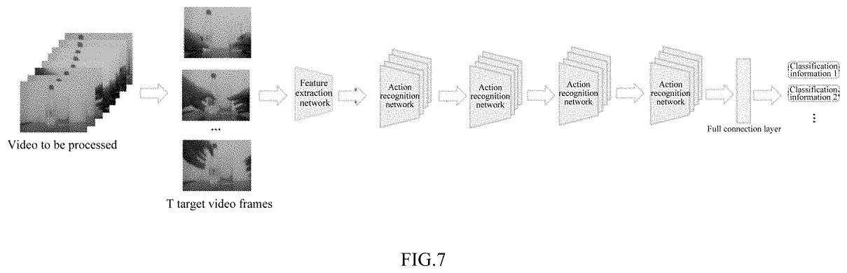

FIG. 7 shows a schematic diagram of an application of a video processing method according to an embodiment of the present disclosure. As shown in 6, the video to be processed may be any video that includes one or more target objects, and T target video frames can be determined from a plurality of video frames of the video to be processed through sampling or the like. For example, the video to be processed can be divided into T (for example, T is 8 or 16) video clips, and one video frame is randomly sampled in each video clip as the target video frame.

In a possible implementation, feature extraction may be performed on the plurality of target video frames through a feature extraction network of the neural network. The feature extraction network may include one or more convolution layers, and may perform convolution process on a plurality of target video frames to obtain feature maps of the plurality of target video frames. For example, among T target video frames, each target video frame can be input to the feature extraction network by being divided into C channels (for example, the three channels of R, G and B). The size of the target video frame is H×W (e.g., 224×224), and the values of C, H and W may all change after the feature extraction process.

In a possible implementation, the feature maps can be processed by an M-level action recognition network. The M-level action recognition network can be M cascaded action recognition networks. Each action recognition network has a same network structure, and is part of the neutral network. As shown in FIG. 6, the M-level action recognition network may form a plurality of groups, a neural network level such as a convolution layer or an activation layer may exist between the respective groups, or there may be no neural network level between groups and respective groups of action recognition networks may be directly cascaded. The total number of the respective groups of action recognition networks is M.

In a possible implementation, the first level action recognition network can process the T groups of feature maps to obtain the first level action recognition features, and the first level action recognition features can be used as input information for the second level action recognition network. The second level action recognition network can process the first level action recognition features to obtain the second level action recognition features, and the second level action recognition features can be used as input information for the third-level action recognition network, and so on.

In a possible implementation, taking the i^{th} level action recognition network as an example, the i^{th} level action recognition network can take the (i−1)^{th} level action recognition features as input information for process, and a first convolution process can be performed on the (i−1)^{th} level action recognition features through a 2D convolution layer with a convolution kernel of 1×1. The dimension of the (i−1)^{th} level action recognition features can be reduced to obtain the first feature information.

In a possible implementation, the i^{th} level action recognition network can perform a spatiotemporal feature extraction process and a motion feature extraction process on the first feature information separately; for example, the process can be divided separately into a spatiotemporal feature extraction branch and a motion feature extraction branch.

In a possible implementation, the spatiotemporal feature extraction branch may firstly reconstruct the first feature information. For example, a feature matrix of the first feature information may be reconstructed into a row vector or a column vector to obtain the second feature information. The second convolution process is performed on each channel of the second feature information through a 1D convolution layer with a convolution kernel of 3×1, so as to obtain the third feature information with less amount of computation. Further, the third feature information can be reconstructed to obtain the fourth feature information in the form of a matrix, and the fourth feature information can be subjected to a convolution process through a 2D convolution layer with a convolution kernel of 3×3, to obtain the spatiotemporal feature information.

In a possible implementation, the motion feature extraction branch may firstly reduce the dimension of the channels of the first feature information through a 2D convolution layer with a convolution kernel of 1×1. For example, the number of channels C of the first feature information can be reduced to C/16, to obtain the fifth feature information corresponding to the respective target video frame. Taking the fifth feature information corresponding to the k^{th} target video frame as an example, a third convolution process is performed on channels of the fifth feature information corresponding to the (k+1)^{th} target video frame through a 2D convolution layer with a convolution kernel of 3×3, and the result of the third convolution process is subtracted by the k^{th} fifth feature information, to obtain a sixth feature information corresponding to the k^{th} target video frame. By this, the sixth feature information corresponding to the first T−1 target video frames can be obtained, and the fifth feature information corresponding to the T^{th} target video frame can be subtracted by a result of the third convolution process on a matrix with all parameters being 0 to obtain the sixth feature information corresponding to the T^{th} target video frame, that is, T pieces of sixth feature information can be obtained. Further, T pieces of sixth feature information can be combined, and the dimension of the sixth feature information can be increased through a 2D convolution layer with a convolution kernel of 1×1, to obtain the motion feature information.

In a possible implementation, the spatiotemporal feature information and the motion feature information are summed to obtain the seventh feature information, and a fourth convolution process may be performed on the seventh feature information through a 2D convolution layer with a convolution kernel of 1×1. The dimension of the seventh feature information can be increased so that the dimension of the seventh feature information can be converted to the same dimension as the (i−1)^{th} level action recognition feature; and the seventh feature information is summed with the (i−1)^{th} level action recognition feature to obtain the i^{th} level action recognition feature.

In a possible implementation, the action recognition feature output by the M^{th} level action recognition network can be determined as the action recognition feature of the target video frame, and the action recognition feature of the target video frame can be input into the full connection layer of the neural network for process, to obtain the classification information corresponding to the respective target video frames, such as classification information 1, classification information 2, and the likes. In an example, the classification information may be a vector, and the classification information corresponding to T target video frames can be averaged to obtain the classification result of the video to be processed. The classification result may also be a vector, which may represent probabilities of the video to be processed belonging to categories. In an example, the classification result may be a 400-dimension vector, which includes 400 parameters respectively representing the probabilities that the video to be processed belonging to 400 categories. The categories may be categories of actions of the target object in the video to be processed, for example, actions such as walking, raising a cup and eating. For example, in this vector, the second parameter has the largest value, that is, the probability that the video to be processed belongs to the second category is the highest. It can be determined that the video to be processed belongs to the second category.

In a possible implementation, the video processing method can identify similar actions, such as closing a door and opening a door, and sunset and sunrise, through the spatiotemporal feature information and the action feature information. In addition, the video processing method requires a small amount of computation with high processing efficiency. The video processing method can be used in real-time classification of a video, for example, for prison monitoring to determine in real time whether a criminal suspect commits prison break. It can be used for subway monitoring, to determine in real time the operating status of subway vehicles and passenger flow status. It can be used in the field of security, to determine in real time whether someone is performing a dangerous action in the monitored area. The present disclosure does not limit the application field of the video processing method.

It can be understood that the various method embodiments mentioned in the present disclosure can be combined with each other to form a combined embodiment without departing from the principle and logic of the present disclosure; the combined embodiment will not be described herein in detail to avoid repetition.

FIG. 8 shows a block diagram of a video processing apparatus according to an embodiment of the present disclosure. As shown in FIG. 8, the video processing apparatus includes:

a feature extraction module 11, configured to perform a feature extraction on a plurality of target video frames of a video to be processed through a feature extraction network, to obtain feature maps of the plurality of target video frames;

an action recognition module 12, configured to perform an action recognition process on the feature maps of the plurality of target video frames through an M-level action recognition network, to obtain action recognition features of the plurality of target video frames; where M is an integer greater than or equal to 1, the action recognition process includes a spatiotemporal feature extraction process based on the feature maps of the plurality of target video frames, and a motion feature extraction process based on motion difference information between the feature maps of the plurality of target video frames, and the action recognition feature includes spatiotemporal feature information and motion feature information;

a classification module 13, configured to determine a classification result of the video to be processed according to the action recognition features of the plurality of target video frames.

In a possible implementation, the action recognition module is further configured to: process the feature maps of the plurality of target video frames through a first level action recognition network, to obtain first level action recognition features; process (i−1)^{th} level action recognition features through an i^{th} level action recognition network to obtain i^{th} level action recognition features, where i is an integer and 1<i<M, and action recognition features of respective levels correspond to the feature maps of the plurality of target video frames; and process the (M−1)^{th} level action recognition features through an M^{th} level action recognition network, to obtain the action recognition features of the plurality of target video frames.

In a possible implementation, the action recognition module is further configured to: perform a first convolution process on the (i−1)^{th} level action recognition features to obtain first feature information, where the first feature information corresponds to the feature maps of the plurality of target video frames respectively; perform a spatiotemporal feature extraction process on the first feature information, to obtain the spatiotemporal feature information; perform a motion feature extraction process on the first feature information, to obtain the motion feature information; and obtain the i^{th} level action recognition features at least based on the spatiotemporal feature information and the motion feature information.

In a possible implementation, the action recognition module is further configured to: obtain the i^{th} level action recognition features based on the spatiotemporal feature information, the motion feature information, and the (i−1)^{th} level action recognition features.

In a possible implementation, the action recognition module is further configured to: perform dimensional reconstruction processes respectively on the first feature information corresponding to the feature maps of the plurality of target video frames, to obtain second feature information, where the second feature information has a different dimension from the first feature information; perform second convolution processes respectively on channels of the second feature information to obtain third feature information, where the third feature information represents time features of the feature maps of the plurality of target video frames; perform a dimensional reconstruction process on the third feature information to obtain fourth feature information, where the fourth feature information has a same dimension as the first feature information; and perform a spatial feature extraction process on the fourth feature information, to obtain the spatiotemporal feature information.

In a possible implementation, the first feature information includes multiple row vectors or column vectors, and the action recognition module is further configured to: perform splicing processes on the multiple row vectors or column vectors of the first feature information to obtain the second feature information, where the second feature information includes one row vector or column vector.

In a possible implementation, the action recognition module is further configured to: perform dimensional reduction processes on channels of the first feature information to obtain fifth feature information, where the fifth feature information corresponds to respective target video frames of the video to be processed; perform a third convolution process on the fifth feature information corresponding to a (k+1)^{th} target video frame; and subtract it by the fifth feature information corresponding to a k^{th} target video frame, to obtain sixth feature information corresponding to the k^{th} target video frame, where, k is an integer and 1≤k<T, T is the number of target video frames, and T is an integer greater than 1, the sixth feature information represents motion difference information between the fifth feature information corresponding to the (k+1)^{th} target video frame and the fifth feature information corresponding to the k^{th} target video frame; and perform a feature extraction process on the sixth feature information corresponding to the respective target video frames, to obtain the motion feature information.

In a possible implementation, the action recognition module is further configured to: perform a summation process on the spatiotemporal feature information and the motion feature information to obtain seventh feature information; and perform on the seventh feature information a fourth convolution process, and a summation process with the (i−1)^{th} level action recognition features, to obtain the i^{th} level action recognition features.

In a possible implementation, the classification module is further configured to: perform a full connection process on the action recognition features of the target video frames respectively, to obtain classification information of the respective target video frames; and perform an averaging process on the classification information of the respective target video frames, to obtain a classification result of the video to be processed.

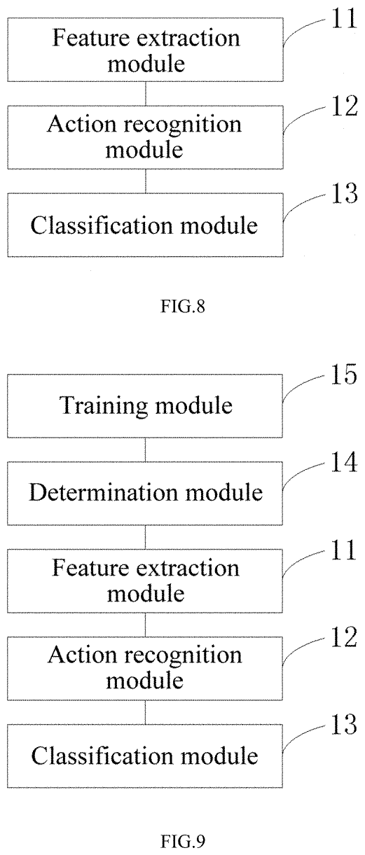

FIG. 9 shows a block diagram of a video processing apparatus according to an embodiment of the present disclosure. As shown in FIG. 9, the video processing apparatus further includes:

a determination module 14 configured to determine a plurality of target video frames from a video to be processed.

In a possible implementation, the determination module is further configured to: divide the video to be processed into a plurality of video clips; and determine randomly at least one target video frame from each video clip to obtain the plurality of target video frames.

In a possible implementation, the video processing apparatus is implemented by a neural network, and the neural network includes at least the feature extraction network and the M-level action recognition network. The apparatus further includes: a training module 15 configured to train the neural network by a sample video and a category label of the sample video.

In a possible implementation, the training module is further configured to: determine a plurality of sample video frames from the sample video; process the sample video frames through the neural network, to determine a classification result of the sample video; determine a network loss of the neural network according to the classification result and a category label of the sample video; and adjust network parameters of the neural network according to the network loss.

In addition, the present disclosure also provides a video processing apparatus, an electronic device, a computer-readable storage media, and a program, all of which can be used to implement any video processing method provided in the present disclosure. For corresponding technical solutions and descriptions, refer to the corresponding descriptions in the method section, which will not be described herein again.

Those skilled in the art can understand that in the above methods in the detailed description, the drafted order of the steps does not mean a strict execution order to constitute any limitation to the implementation process. The specific execution order of respective steps should be determined by their functions and a possible internal logic.

In some embodiments, functions or modules included in the apparatus provided in the embodiments of the present disclosure can be used to execute the methods described in the above method embodiments. For specific implementation, refer to the description of the above method embodiments, which will not be described herein again for simplicity.

An embodiment of the present disclosure also provides a computer-readable storage medium having computer program instructions stored thereon, where the computer program instructions, when executed by a processor, implement the above method. The computer-readable storage medium may be a non-volatile computer-readable storage medium.

An embodiment of the present disclosure also provides an electronic device, including: a processor; and a memory for storing processor executable instructions; the processor is configured to execute the above method.

The electronic device can be provided as a terminal, a server or another form of device.

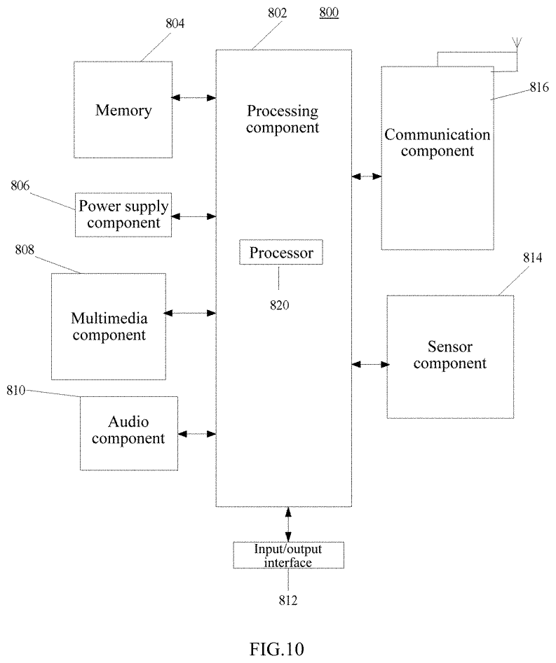

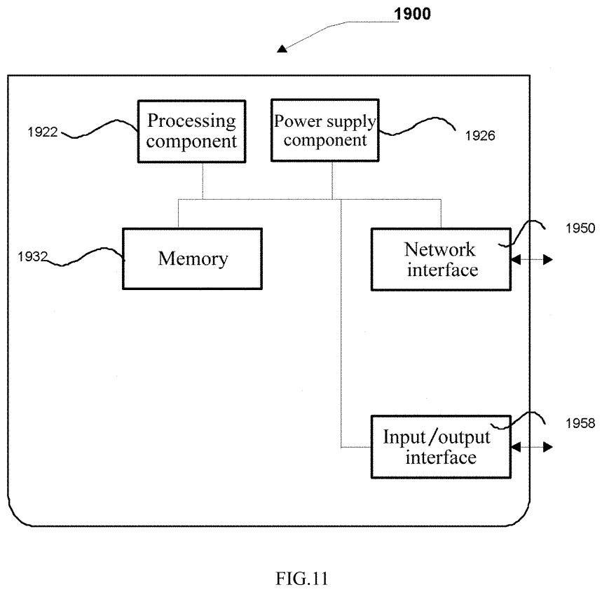

FIG. 10 shows a block diagram of an electronic device 800 according to an exemplary embodiment. For example, the electronic device 800 may be a mobile phone, a computer, a digital broadcasting terminal, a messaging device, a game console, a tablet device, a medical device, a fitness device, a personal digital assistant, etc.

With reference to FIG. 10, the electronic device 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operations of the electronic device 800, such as operations associated with display, telephone call, data communication, camera operation, and recording operation. The processing component 802 may include one or more processors 820 to execute instructions to complete all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations of the electronic device 800. Examples of these data include instructions for any application or method operating on the electronic device 800, contact data, phone book data, messages, pictures, videos, etc. The memory 804 can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power supply component 806 supplies power to various components of the electronic device 800. The power supply component 806 may include a power management system, one or more power supplies, and other components associated with the generation, management, and distribution of power for the electronic device 800.

The multimedia component 808 includes a screen that provides an output interface between the electronic device 800 and a user. In some embodiments, the screen may include a liquid crystal display (LCD) and a touch panel (TP). If the screen includes a touch panel, the screen may be implemented as a touch screen to receive an input signal from the user. The touch panel includes one or more touch sensors to sense a touch, a sliding, and gestures on the touch panel. The touch sensor may not only sense the boundary of a touch or a slide action, but also detect a duration and a pressure related to the touch or slide operation. In some embodiments, the multimedia component 808 includes a front-facing camera and/or a rear-facing camera. When the electronic device 800 is in an operation mode, such as a photo capturing mode or a video recording mode, the front-facing camera and/or the rear-facing camera can receive external multimedia data. Each front-facing camera and rear-facing camera may be a fixed optical lens system or have a focal length and optical zoom capabilities.

The audio component 810 is configured to output and/or input audio signal. For example, the audio component 810 includes a microphone (MIC). When the electronic device 800 is in an operation mode, such as a calling mode, a recording mode, and a voice recognition mode, the microphone is configured to receive external audio signal. The received audio signals may be further stored in the memory 804 or transmitted via the communication component 816. In some embodiments, the audio component 810 further includes a speaker for outputting audio signal.

The I/O interface 812 provides an interface between the processing component 802 and peripheral interface modules. The peripheral interface module may be a keyboard, a click wheel, a button, and the likes. These buttons may include, but are not limited to, a homepage button, a volume button, a start button, and a lock-on button.

The sensor component 814 includes one or more sensors for providing the electronic device 800 with state evaluation of various aspects. For example, the sensor component 814 can detect the on/off state of the electronic device 800, and the relative positioning of components such as a display and a keypad of the electronic device 800. The sensor component 814 may also detect a position change of the electronic device 800 or a component of the electronic device 800, the presence or absence of contact between a user and the electronic device 800, orientation or acceleration/deceleration of the electronic device 800, and a temperature change of the electronic device 800. The sensor component 814 may include a proximity sensor configured to detect the presence of a nearby object when there is no physical contact. The sensor component 814 may also include an optical sensor, such as a CMOS or CCD image sensor, for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and other devices. The electronic device 800 can access a wireless network based on a communication standard, such as WiFi, 2G, and 3G, or a combination thereof. In an exemplary embodiment, the communication component 816 receives broadcast signal or broadcast related information from an external broadcast management system via a broadcast channel. In an exemplary embodiment, the communication component 816 further includes a near-field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the electronic device 800 can be implemented by one or more application specific integrated circuits (ASIC), digital signal processors (DSP), digital signal processing devices (DSPD), programmable logic devices (PLD), field programmable gate array (FPGA) devices, controllers, microcontrollers, microprocessors, or other electronic components to implement the foregoing methods.

In an exemplary embodiment, it is also provided a non-volatile computer-readable storage medium, such as the memory 804 including computer program instructions, which can be executed by the processor 820 of the electronic device 800 to complete the above method.

An embodiment of the present disclosure also provides a computer program product, including computer-readable code. When the computer-readable codes is running on a device, a processor in the device executes instructions for implementing the method provided in any of the foregoing embodiments.

The computer program product can be specifically implemented by hardware, software or a combination thereof. In an alternative embodiment, the computer program product is specifically embodied as a computer storage medium. In another alternative embodiment, the computer program product is specifically embodied as a software product, such as a Software Development Kit (SDK).

FIG. 11 shows a block diagram of an electronic device 1900 according to an exemplary embodiment. For example, the electronic device 1900 may be provided as a server. With reference to FIG. 11, the electronic device 1900 includes a processing component 1922, which further includes one or more processors, and a memory resource represented by a memory 1932, for storing instructions that can be executed by the processing component 1922, such as an application program. The application program stored in the memory 1932 may include one or more modules each corresponding to a set of instructions. In addition, the processing component 1922 is configured to execute the instructions to perform the foregoing method.

The electronic device 1900 may further include a power supply component 1926 configured to perform power management of the electronic device 1900, a wired or wireless network interface 1950 configured to connect the electronic device 1900 to a network, and an input/output (I/O) interface 1958. The electronic device 1900 can operate an operating system stored in the memory 1932, such as Windows Server™, Mac OS X™, Unix™, Linux™, FreeBSD™ or the like.

In an exemplary embodiment, it is also provided a non-volatile computer-readable storage medium, such as the memory 1932 including computer program instructions, which can be executed by the processing component 1922 of the electronic device 1900 to complete the foregoing method.

The present disclosure may be a system, a method, and/or a computer program product. The computer program product may include a computer-readable storage medium having computer-readable program instructions thereon for enabling a processor to implement various aspects of the present disclosure.

The computer-readable storage medium may be a tangible device that can hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination thereof. More specific examples of the computer-readable storage medium (as a non-exhaustive list) include: a portable computer disk, a hard disk, a random access Memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, a punch card or a convex structure in a groove on which instructions are stored for instance, and any suitable combination thereof. The computer-readable storage medium used herein is not interpreted as a transient signal per se, such as a radio wave or another freely propagating electromagnetic wave, an electromagnetic wave propagating through a waveguide or another transmission medium (for example, a light pulse through a fiber optic cable), or an electrical signal transmitted through a wire.

The computer-readable program instructions described herein can be downloaded from the computer-readable storage medium to various computing/processing devices, or downloaded to an external computer or external storage device via a network, such as the Internet, a local area network, a wide area network, and/or a wireless network. The network may include a copper transmission cable, optical fiber transmission, wireless transmission, a router, a firewall, a switch, a gateway computer, and/or an edge server. A network adapter card or a network interface in each computing/processing device receives computer-readable program instructions from the network, and forwards the computer-readable program instructions for storage in the computer-readable storage medium in each computing/processing device.

The computer program instructions used to perform the operations of the present disclosure may be assembler instructions, instruction set architecture (ISA) instructions, machine instructions, machine-related instructions, microcodes, firmware instructions, state setting data, or source codes or object codes written in any combination of one or more programming languages, including a object-oriented programming language such as Smalltalk, C++, etc., and a conventional procedural programming language such as “C” language or a similar programming language. The computer-readable program instructions can be executed entirely on a computer of a user, partly on a computer of a user, as a stand-alone software package, partly on a computer of a user and partly on a remote computer, or entirely on a remote computer or a server. In the case of a remote computer, the remote computer can be connected to the computer pf the user through any kind of network, including a local area network (LAN) or a wide area network (WAN), or can be connected to an external computer (for example, via the Internet of an Internet service provider). In some embodiments, an electronic circuit, such as a programmable logic circuit, a field programmable gate array (FPGA), or a programmable logic array (PLA), can be customized by using the state information of the computer-readable program instructions. The electronic circuit can execute computer-readable program instructions to implement various aspects of the present disclosure.

Herein, various aspects of the present disclosure are described with reference to flowcharts and/or block diagrams of the methods, device (system) and computer program product according to the embodiments of the present disclosure. It should be understood that each block of the flowchart and/or block diagram and a combination of blocks in the flowchart and/or block diagram can be implemented by computer-readable program instructions.

These computer-readable program instructions can be provided to a processor of a general-purpose computer, a special-purpose computer, or another programmable data processing device, thereby producing a machine that allows these instructions, when executed by the processors of the computer or another programmable data processing device, to form an apparatus that implements the functions/actions specified in one or more blocks of the flowcharts and/or block diagrams. These computer-readable program instructions may also be stored in a computer-readable storage medium. These instructions allow the computer, programmable data processing apparatus, and/or another device to work in a specific manner. Thus, the computer-readable medium storing instructions includes an article, which includes instructions for implementing various aspects of the functions/actions specified in one or more blocks of the flowcharts and/or block diagrams.

The computer-readable program instructions may also loaded onto a computer, another programmable data processing apparatus, or other devices, so that a series of operation steps are executed on the computer, another programmable data processing apparatus, or other devices to produce a computer-implemented process, so that the instructions executed on the computer, another programmable data processing apparatus, or other devices implement the functions/actions specified in one or more blocks of the flowcharts and/or block diagrams.

The flowcharts and block diagrams in the accompanying drawings show the architectures, functions, and operations that can be implemented by the system, method, and computer program product according to various embodiments of the present disclosure. In this regard, each block in a flowchart or a block diagram may represent part of a module, a program segment, or an instruction, which contains one or more executable instructions for implementing the specified logic function. In some alternative implementations, the functions marked in the blocks may also occur in a different order from the order marked in the drawings. For example, two consecutive blocks may actually be executed in parallel, or they may sometimes be executed in a reverse order, depending on the functions involved. It should also be noted that each block in a block diagram and/or a flowchart, and a combination of the blocks in the block diagram and/or flowchart, can be implemented by a dedicated hardware-based system that performs the specified functions or actions, or implemented by a combination of dedicated hardware and computer instructions.

Various embodiments of the present disclosure have been described above, and the above description is exemplary rather than exhaustive, and is not limited to the disclosed embodiments. Without departing from the scope and spirit of the described embodiments, many modifications and changes are apparent to those of ordinary skill in the art. The choice of terms used herein is intended to best explain the principles of the embodiments, a practical application, or a technical improvement to the technology in the market, or to enable other of ordinary skill in the art to understand the embodiments disclosed herein.

What is claimed is:

1. A video processing method, comprising:
performing a feature extraction on a plurality of target video frames of a video to be processed through a feature extraction network, to obtain feature maps of the plurality of target video frames;
performing an action recognition process on the feature maps of the plurality of target video frames through an M-level action recognition network, to obtain action recognition features of the plurality of target video frames; wherein M is an integer greater than or equal to 1, the action recognition process comprises a spatiotemporal feature extraction process based on the feature maps of the plurality of target video frames, and a motion feature extraction process based on motion difference information between the feature maps of the plurality of target video frames, the action recognition feature comprises spatiotemporal feature information and motion feature information; and
determining a classification result of the video to be processed according to the action recognition features of the plurality of target video frames.

2. The method according to claim 1, wherein performing the action recognition process on the feature maps of the plurality of target video frames through the M-level action recognition network to obtain action recognition features of the plurality of target video frames comprises:
processing the feature maps of the plurality of target video frames through a first level action recognition network, to obtain first level action recognition features;
processing (i−1)^{th} level action recognition features through an i^{th} level action recognition network to obtain i^{th} level action recognition features, wherein i is an integer and 1<i<M; action recognition features of respective levels correspond to the feature maps of the plurality of target video frames; and
processing (M−1)^{th} level action recognition features through an M^{th} level action recognition network, to obtain action recognition features of the plurality of target video frames.

3. The method according to claim 2, wherein processing (i−1)^{th} level action recognition features through the i^{th} level action recognition network to obtain i^{th} level action recognition features comprises:
performing a first convolution process on the (i−1)^{th} level action recognition features to obtain first feature information, wherein the first feature information corresponds to the feature maps of the plurality of target video frames respectively;
performing a spatiotemporal feature extraction process on the first feature information, to obtain spatiotemporal feature information;
performing a motion feature extraction process on the first feature information, to obtain motion feature information; and
obtaining the i^{th} level action recognition features at least based on the spatiotemporal feature information and the motion feature information.

4. The method according to claim 3, wherein obtaining the i^{th} level action recognition features at least based on the spatiotemporal feature information and the motion feature information comprises:
obtaining the i^{th} level action recognition features based on the spatiotemporal feature information, the motion feature information, and the (i−1)^{th} level action recognition features.

5. The method according to claim 3, wherein performing the spatiotemporal feature extraction process on the first feature information to obtain spatiotemporal feature information comprises:
performing dimensional reconstruction processes respectively on the first feature information corresponding to the feature maps of the plurality of target video frames, to obtain second feature information, wherein the second feature information has a different dimension from the first feature information;
performing second convolution processes respectively on channels of the second feature information to obtain third feature information, wherein the third feature information represents time features of the feature maps of the plurality of target video frames;
performing a dimensional reconstruction process on the third feature information to obtain fourth feature information, wherein the fourth feature information has a same dimension as the first feature information; and
performing a spatial feature extraction process on the fourth feature information, to obtain the spatiotemporal feature information.

6. The method according to claim 5, wherein, the first feature information comprises multiple row vectors or column vectors, and
performing dimensional reconstruction processes respectively on the first feature information corresponding to the feature maps of the plurality of target video frames comprises:
performing splicing processes on the multiple row vectors or column vectors of the first feature information to obtain the second feature information, wherein the second feature information comprises one row vector or column vector.

7. The method according to claim 3, wherein performing the motion feature extraction process on the first feature information to obtain motion feature information comprises:
performing dimensional reduction processes on channels of the first feature information to obtain fifth feature information, wherein the fifth feature information corresponds to respective target video frames of the video to be processed;
performing a third convolution process on the fifth feature information corresponding to a (k+1)^{th} target video frame, and subtracting it by the fifth feature information corresponding to a k^{th} target video frame, to obtain sixth feature information corresponding to the k^{th} target video frame, where k is an integer and 1≤k<T, T is a number of the target video frames, and T is an integer greater than 1, the sixth feature information represents motion difference information between the fifth feature information corresponding to the (k+1)^{th} target video frame and the fifth feature information corresponding to the k^{th} target video frame; and
performing a feature extraction process on the sixth feature information corresponding to the respective target video frames, to obtain the motion feature information.

8. The method according to claim 4, wherein obtaining the i^{th} level action recognition features based on the spatiotemporal feature information, the motion feature information, and the (i−1)^{th} level action recognition features comprises:
performing a summation process on the spatiotemporal feature information and the motion feature information, to obtain seventh feature information; and
performing on the seventh feature information a fourth convolution process, and a summation process with the (i−1)^{th} level action recognition features, to obtain the i^{th} level action recognition features.

9. The method according to claim 1, wherein determining the classification result of the video to be processed according to the action recognition features of the plurality of target video frames comprises:
performing a full connection process on the action recognition features of the target video frames respectively, to obtain classification information of the respective target video frames; and
performing an averaging process on the classification information of the respective target video frames, to obtain the classification result of the video to be processed.

10. The method according to claim 1, further comprising:
determining a plurality of target video frames from the video to be processed.

11. The method according to claim 10, wherein determining the plurality of target video frames from the video to be processed comprises:
dividing the video to be processed into a plurality of video clips; and
determining randomly at least one target video frame from each video clip to obtain the plurality of target video frames.

12. The method according to claim 1, wherein the video processing method is implemented through a neural network, and the neural network at least comprises the feature extraction network and the M-level action recognition network,
the method further comprises:
training the neural network by a sample video and a category label of the sample video.

13. The method according to claim 12, wherein training the neural network by the sample video and the category label of the sample video comprises:
determining a plurality of sample video frames from the sample video,
processing the sample video frames through the neural network, to determine a classification result of the sample video;
determining a network loss of the neural network according to the classification result and a category label of the sample video; and
adjusting network parameters of the neural network according to the network loss.

14. A video processing apparatus, comprising:
a processor; and
a memory for storing processor executable instructions;
wherein the processor is configured to invoke the instructions stored on the memory to:
perform a feature extraction on a plurality of target video frames of a video to be processed through a feature extraction network, to obtain feature maps of the plurality of target video frames;
perform an action recognition process on the feature maps of the plurality of target video frames through an M-level action recognition network, to obtain action recognition features of the plurality of target video frames; wherein M is an integer greater than or equal to 1, the action recognition process comprises a spatiotemporal feature extraction process based on the feature maps of the plurality of target video frames, and a motion feature extraction process based on motion difference information between the feature maps of the plurality of target video frames, the action recognition feature comprises spatiotemporal feature information and motion feature information; and
determine a classification result of the video to be processed according to the action recognition features of the plurality of target video frames.

15. The apparatus according to claim 14, wherein the processor is further configured to invoke the instructions stored on the memory to:
process the feature maps of the plurality of target video frames through a first level action recognition network, to obtain first level action recognition features;
process (i−1)^{th} level action recognition features through an i^{th} level action recognition network to obtain i^{th} level action recognition features, wherein i is an integer and 1<i<M, wherein action recognition features of respective levels correspond to the feature maps of the plurality of target video frames; and
process (M−1)^{th} level action recognition features through an M^{th} level action recognition network, to obtain action recognition features of the plurality of target video frames.

16. The apparatus according to claim 15, wherein the processor is further configured to invoke the instructions stored on the memory to:
perform a first convolution process on the (i−1)^{th} level action recognition features to obtain first feature information, wherein the first feature information corresponds to the feature maps of the plurality of target video frames respectively;
perform a spatiotemporal feature extraction process on the first feature information, to obtain the spatiotemporal feature information;
perform a motion feature extraction process on the first feature information, to obtain the motion feature information; and
obtain the i^{th} level action recognition features based on the spatiotemporal feature information and the motion feature information.

17. The apparatus according to claim 16, wherein the processor is further configured to invoke the instructions stored on the memory to:
obtain the i^{th} level action recognition features based on the spatiotemporal feature information, the motion feature information, and the (i−1)^{th} level action recognition features.

18. The apparatus according to claim 16, wherein the processor is further configured to invoke the instructions stored on the memory to:
perform dimensional reconstruction processes respectively on the first feature information corresponding to the feature maps of the plurality of target video frames, to obtain second feature information, wherein the second feature information has a different dimension from the first feature information;
perform second convolution processes respectively on channels of the second feature information to obtain third feature information, wherein the third feature information represents time features of the feature maps of the plurality of target video frames;
perform a dimensional reconstruction process on the third feature information to obtain fourth feature information, wherein the fourth feature information has a same dimension as the first feature information; and
perform a spatial feature extraction process on the fourth feature information, to obtain the spatiotemporal feature information.

19. The apparatus according to claim 16, wherein the processor is further configured to invoke the instructions stored on the memory to:
perform dimensional reduction processes on channels of the first feature information to obtain fifth feature information, wherein the fifth feature information corresponds to respective target video frames of the video to be processed;
perform a third convolution process on the fifth feature information corresponding to a (k+1)^{th} target video frame, and subtracting it by the fifth feature information corresponding to a k^{th} target video frame, to obtain sixth feature information corresponding to the k^{th} target video frame, where k is an integer and 1≤k<T, T is the number of target video frames, and T is an integer greater than 1, the sixth feature information represents motion difference information between the fifth feature information corresponding to the (k+1)^{th} target video frame and the fifth feature information corresponding to the k^{th} target video frame; and
perform a feature extraction process on the sixth feature information corresponding to the respective target video frames, to obtain the motion feature information.

20. A non-transitory computer-readable storage medium having computer program instructions stored thereon, wherein when the computer program instructions are executed by a processor, the processor is caused to:
perform a feature extraction on a plurality of target video frames of a video to be processed through a feature extraction network, to obtain feature maps of the plurality of target video frames;
perform an action recognition process on the feature maps of the plurality of target video frames through an M-level action recognition network, to obtain action recognition features of the plurality of target video frames; wherein M is an integer greater than or equal to 1, the action recognition process comprises a spatiotemporal feature extraction process based on the feature maps of the plurality of target video frames, and a motion feature extraction process based on motion difference information between the feature maps of the plurality of target video frames, the action recognition feature comprises spatiotemporal feature information and motion feature information; and
determine a classification result of the video to be processed according to the action recognition features of the plurality of target video frames.
